(19) United States
(12) Patent Application Publication
(10) Pub. No.: US 2008/0301987 A1
(43) Pub. Date: Dec. 11, 2008

(54) Position displaying device with a promotional function

(75) Inventor: Giuseppe Bigolin, Vicenza (IT)

Correspondence Address: HEDMAN & COSTIGAN P.C., 1185 AVENUE OF THE AMERICAS, NEW YORK, NY, 10036, US

(73) Assignee: SELLE ITALIA S.R.L, Vicenza (IT)

(21) Appl. No.: 11/810,476

(22) Filed: Jun. 6, 2007

(51) Int. Cl. G06F 13/20; G06F 13/00

(52) U.S. Cl. 40/542; 40/541

(57) ABSTRACT

A promotional position displaying device comprises a light display, comprising a trademark or other words or inscriptions to be displayed, which is so applied to an article as to be easily visible.

### BACKGROUND OF THE INVENTION

The present invention relates to a position displaying device, designed for also meeting a promotional function.

As is known trademarks, words, logos and other indications or inscriptions are frequently applied both on vehicles and on cloth articles, bags, and so on, for meeting an essentially promotional function, both related to the trademark and the vehicle itself.

Such a vehicle definition must be considered in a broad sense, to indicate an object or article bearing its trademark, as well as other trademarks of third parties.

For meeting an advertising or promotional function, is also known in the art to apply display devices, such as position indicators, lights, luminescent objects, to motor vehicles and cloth articles, and, in particular, to achieve safety functions, to allow persons and articles to be clearly seen under poor illuminating conditions.

### SUMMARY OF THE INVENTION

The aim of the present invention is to provide such a display device designed for combining into a single construction both safety and promotional functions.

Within the scope of the above mentioned aim, a main object of the invention is to provide such a display device which has a very small size and can be easily applied to a broad range of articles.

Yet another object of the present invention is to provide such a display device which is practically free of maintenance.

According to one aspect of the present invention, the above mentioned aim and objects, as well as yet other objects, which will become more apparent hereinafter, are achieved by a promotional position display device, characterized in that said device comprises a light display, including a trademark or other words or indications to be displayed, and being so applied to an article that it can be easily seen.

### BRIEF DESCRIPTION OF THE DRAWINGS

Further characteristics and advantages of the present invention will become more apparent from the following detailed disclosure of a preferred, though not exclusive, embodiment of the invention, which is illustrated, by way of an indicative, but not limitative, example in the accompanying drawings, where:

FIG. 1 is a top plan view of a saddle including a display device according to the present invention;

FIG. 2 is a rear elevation view of the saddle shown in FIG. 1;

FIG. 3 is a front view of the structure of the display device according to the present invention;

FIG. 4 shows a possible mode of application of the display device according to the present invention, to a hood of a motor vehicle;

FIG. 5 is a front view of a motor vehicle including a display device according to the present invention; and

FIG. 6 shows a possible application of the inventive display device to a jacket.

### DESCRIPTION OF THE PREFERRED EMBODIMENT

With reference to the number references of the above mentioned figures, the display device according to the present invention, which has been generally indicated by the reference number 1, essentially comprises a light display 2, for displaying a trademark or any desired words or indications to be displayed, and being applied to an article so as to be clearly seen.

More specifically, the light display can be power supplied by a battery pack, or, preferably, through a solar panel, for example including photovoltaic cell, associated to an accumulating device.

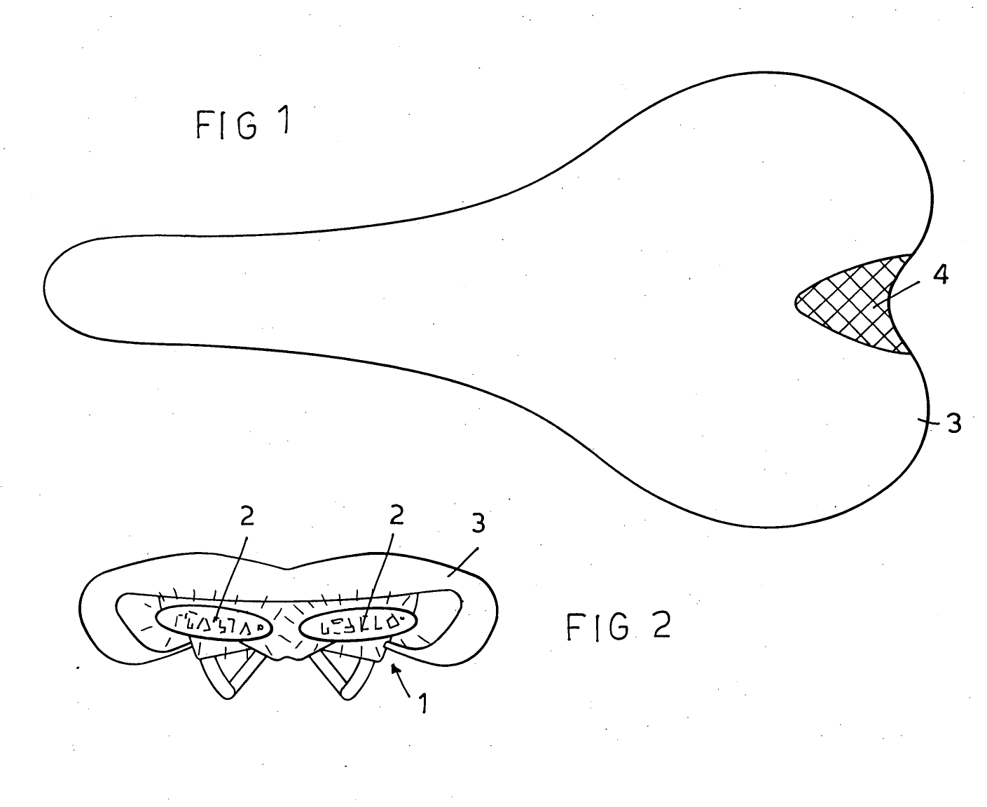

FIGS. 1 and 2 show the display device according to the present invention applied to a saddle 3, for example bicycle saddle.

This saddle 3 comprises a small solar panel 4, of a photovoltaic cell type, applied on a rear portion of the saddle, and a light display 2 applied on the rear portion of the saddle, thereby it can be easily seen from the rear of the bicycle, even with the driver seated on the saddle.

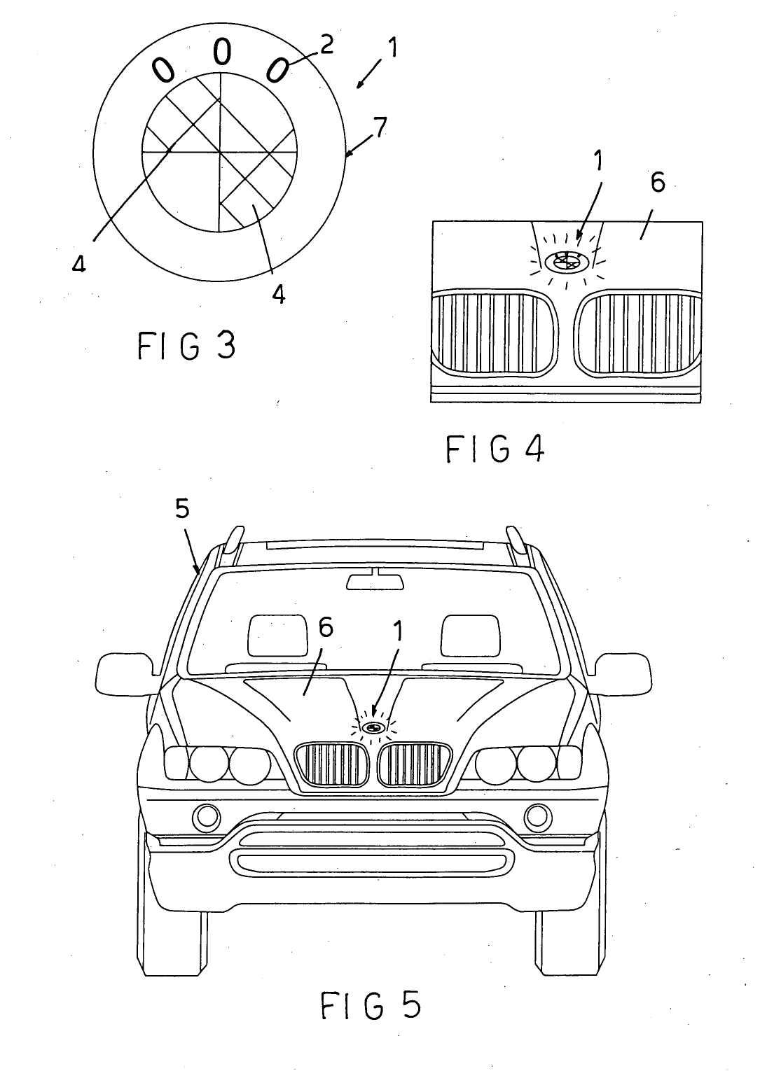

FIGS. 3 to 5 show the display device according to the present invention applied to a motor vehicle or car 5 and, in particular, to the motor vehicle or car hood 6.

In particular, said display 2 and solar panel are built-in into a single integrated body 7, which, at the rear thereof, also supports the accumulator or battery pack, not shown in the figures.

In particular, said integrated body 7 can be arranged on the front of the motor vehicle, i.e. on the motor vehicle hood, as shown in the figures, or at any other desired suitable positions.

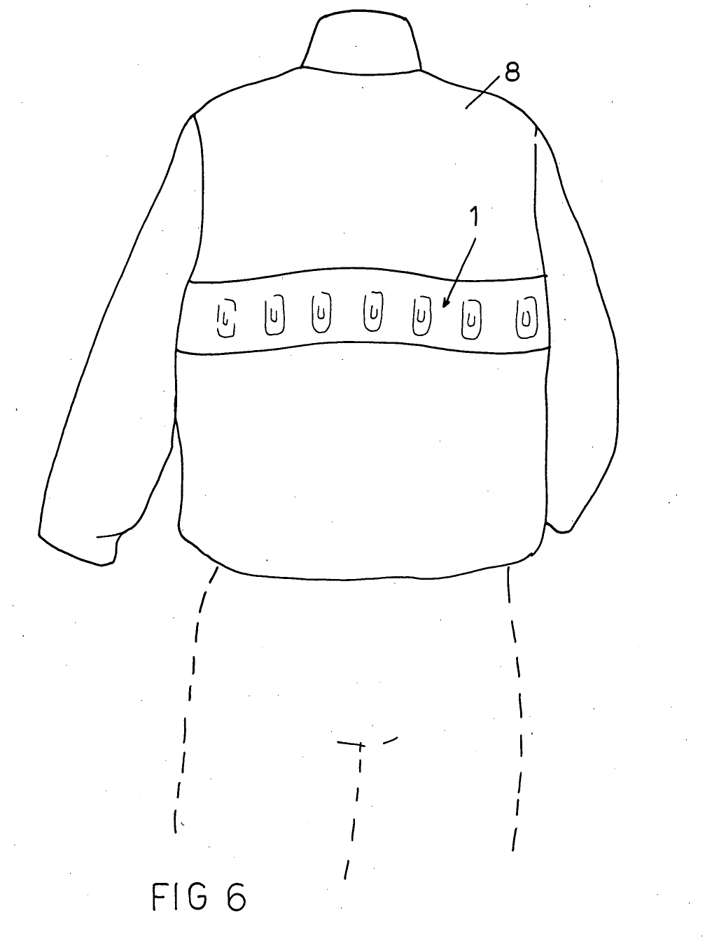

FIG. 6 shows the display device according to the present invention applied to a garment 8, in particular a sports jacket to be used, for example, by hikers, cyclists, motorcyclists, and so on.

In such an application, the device, which can also be built-in into said individual body 7, as above disclosed, is applied on the rear, the sleeves, front part or any other desired positions of the garment.

Preferably, said light device comprises “LED's (Light Emission Devices), which components have a comparatively high light efficiency.

In particular, said light device may be either of a continuous or intermittent type, and, according to requirements, can be actuated either automatically and/or manually.

The power supply provided by the above mentioned solar panel allows the batteries to be quickly recharged, during the day time, both with the article used or with the article in a standby condition, provided that it is properly illuminated.

In this connection it should be pointed out that the display device according to the present invention can be applied to a broad range of articles, of which the above illustrated articles constitute only some exemplary applications.

In fact, the subject device can be applied to a lot of transport devices, such as bicycles, motorcycles, cars, boats and to a lot of different garments, as well as to shoes, bags or any other articles adapted to support a trademark while operating as a position indicator.

It has been found that the invention fully achieves the intended aim and objects.

In fact, the invention provides a position display device, which can be applied to a broad range of articles, and integrating, in a single construction, both promotional and safety functions.

In practicing the invention, the used materials, as well as the contingent size and shapes, can be any, depending on requirements.

1-14. (canceled)

15. A promotional position display device, in particular applied to a bicycle saddle, wherein said device comprises, in said bicycle saddle, a photovoltaic cell solar panel applied to a rear portion of said bicycle saddle, and a light display also applied on said rear portion of said bicycle saddle, so that said display device can be easily seen from a rear of a bicycle, even if a cyclist is seated on said bicycle saddle.

16. A display device, according to claim 15, wherein said light display and solar panel are so integrated as to form a single body.

17. A display device, according to claim 16, wherein said integrated single body Comprises an accumulator.
